(19) United States
(12) Patent Application Publication
(10) Pub. No.: US 2017/0058598 A1
(43) Pub. Date: Mar. 2, 2017

(54) COVERING DEVICE FOR OPENING OF BUILDING AND HEADRAIL STRUCTURE THEREOF

(71) Applicant: NIEN MADE ENTERPRISE CO., LTD., TAICHUNG CITY (TW)

(72) Inventors: Chih-Yao CHANG, Taichung City (TW); Keng-Hao NIEN, Taichung City (TW)

(21) Appl. No.: 15/348,677

(22) Filed: Nov. 10, 2016

Related U.S. Application Data
(63) Continuation-in-part of application No. 14/603,510, filed on Jan. 23, 2015.

(30) Foreign Application Priority Data
Jan. 24, 2014 (CN) 201420047035.6

(51) Int. Cl. E06B 9/307; E06B 9/324; E06B 9/323

(52) U.S. Cl. CPC E06B 9/307; E06B 9/323; E06B 9/324

(57) ABSTRACT

A headrail structure includes a front side plate, a rear side plate, and a transverse plate, wherein the front side plate and the rear side plate are respectively connected to two different long edges of the transverse plate. The transverse plate of the headrail has at least one opening. The front side plate has a protrusion extending downward, and the protrusion is near the opening. A covering device for a building opening, which includes the headrail structure, is disclosed herein. In the covering device, part of a control unit would be exposed through the opening, or would extend out of the headrail structure through the opening. Whereby, the protrusion of the headrail could shield the opening to make an appearance of the headrail simple and clean, which enhances the quality of the whole covering device.

### BACKGROUND OF THE INVENTION

1. Technical Field

The present invention relates generally to a device for a building, and more particularly to a covering device for an opening of a building, and a headrail structure thereof.

2. Description of Related Art

A window covering is a common covering device for an opening of a building, which typically includes a fixed headrail, a window covering material, and a movable bottom rail. The fixed headrail is provided on a window frame or a building structure, and the window covering material is located between the fixed headrail and the movable bottom rail. When the movable bottom rail is moved up and down relative to the fixed headrail, the window covering material would change a covered area of the opening of the building.

In general, control units having different functions would be provided in the fixed headrail for lowering and raising the movable bottom rail, or for tilting slats of the window covering material. Therefore, a plurality of bores would be provided on the fixed headrail for easily operating the components of the control units, such as the lifting cords, which would pass through said bores to be manipulated. However, the bores would expose parts of the components, and such design significantly affects the overall aesthetic appearance of the covering device. In all aspects, the fixed headrail structure still has room for improvements.

### BRIEF SUMMARY OF THE INVENTION

In view of the above, one objective of the present invention is to provide a covering device for an opening of a building, and a headrail structure thereof, which could enhance the overall texture, and overcome the problems of the conventional headrail structure and the covering device.

The present invention provides a headrail structure, including a front side plate, a rear side plate, and a transverse plate, wherein the front side plate and the rear side plate are respectively connected to two different long edges of the transverse plate. The transverse plate has at least one opening, and the front side plate has a protrusion extending downward, wherein the protrusion is near the opening.

The present invention further provides a covering device for an opening of a building. The covering device includes a fixed headrail formed as the aforementioned headrail structure, a movable bottom rail, and a window covering material provided between the fixed headrail and the movable bottom rail. The window covering material is controllable through at least one control unit. The fixed headrail includes a front side plate, a rear side plate, and a transverse plate, wherein the front side plate and the rear side plate are respectively connected to two different long edges of the transverse plate. The transverse plate has at least one opening, and the front side plate has a protrusion extending downward, wherein the protrusion is near the opening. The control unit is provided in the fixed headrail, and is exposed through the opening thereof.

With the design of above, the opening of the transverse plate could be cleverly shielded by the protrusion of the front side plate, which enhances the overall texture of the covering device.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view, showing the headrail structure of a first embodiment of the present invention;

FIG. 2 is another perspective view of FIG. 1;

FIG. 3 is a cross-sectional view along the line 3-3 in FIG. 2;

FIG. 4 is a cross-sectional view along the line 4-4 in FIG. 2;

FIG. 5 is a perspective view, showing a window covering including the headrail in FIG. 1;

FIG. 6 is a perspective view, showing the headrail and a control unit of the window covering;

FIG. 7 is a perspective view, showing the headrail and a lifting cord;

FIG. 8 is a side view, showing the headrail and a slat tilting structure;

FIG. 9 is a cross-sectional view, showing a combination of the headrail and a housing of the slat tilting structure;

FIG. 10 is a cross-sectional view, showing a combination of the headrail and a cord lock;

FIG. 11 is similar to FIG. 9, showing a combination of a headrail and a housing of a slat tilting structure of a second embodiment of the present invention;

FIG. 12 is a cross-sectional view, showing the headrail smaller than that illustrated in FIG. 11;

FIG. 13 is a cross-sectional view, showing a U-shaped supporting member provided in the headrail;

FIG. 14 is a cross-sectional view, showing an X-shaped supporting member provided in the headrail; and

FIG. 15 is a cross-sectional view, showing a trapezoidal tubular supporting member provided in the headrail.

### DETAILED DESCRIPTION OF THE INVENTION

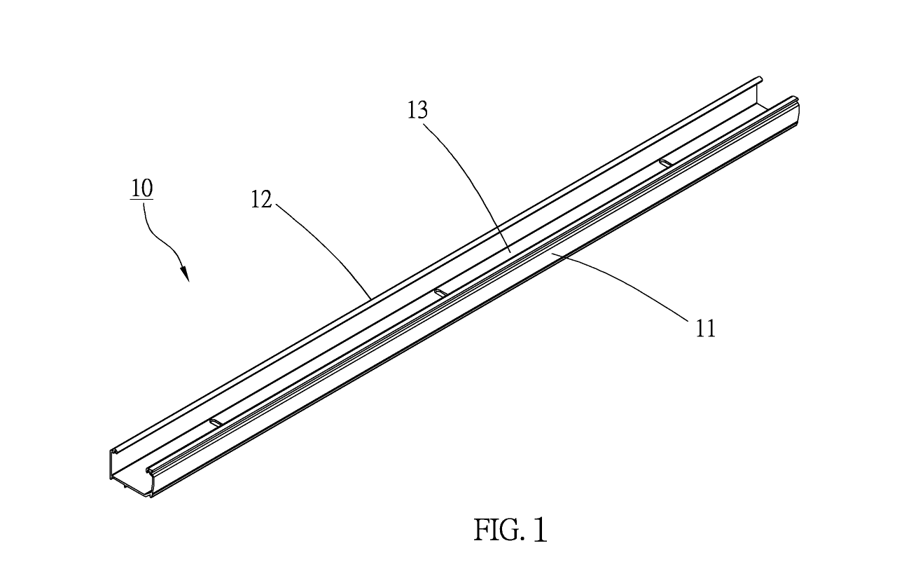

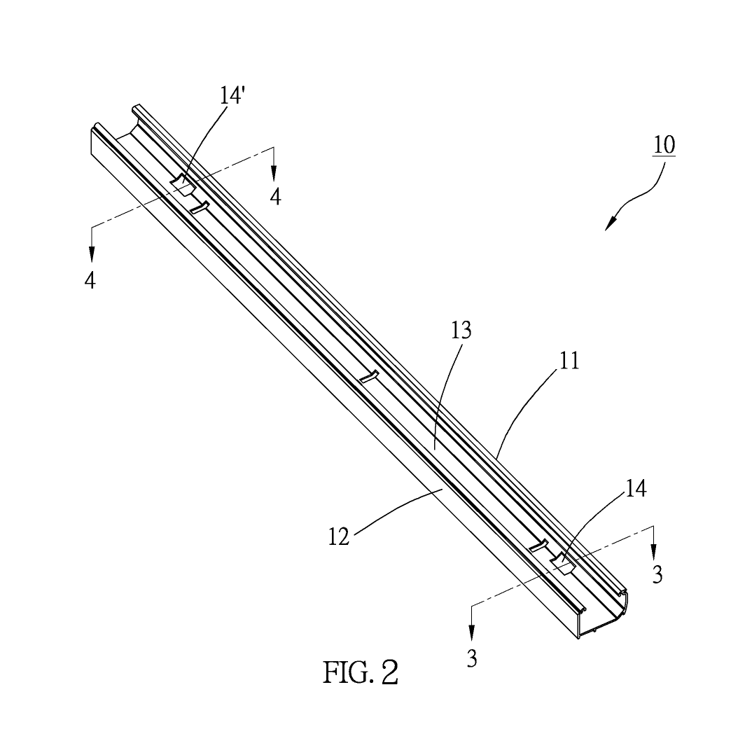

A headrail 10 of a first embodiment of the present invention is shown in FIG. 1 and FIG. 2, including a front side plate 11, a rear side plate 12, and a transverse plate 13. The front side plate 11 and the rear side plate 12 are respectively connected to two different long sides of the transverse plate 13. In the first embodiment, the headrail 10 could be made of any suitable material. For instance, the headrail 10 could be made of a suitable plastic material, or made by aluminum extrusion.

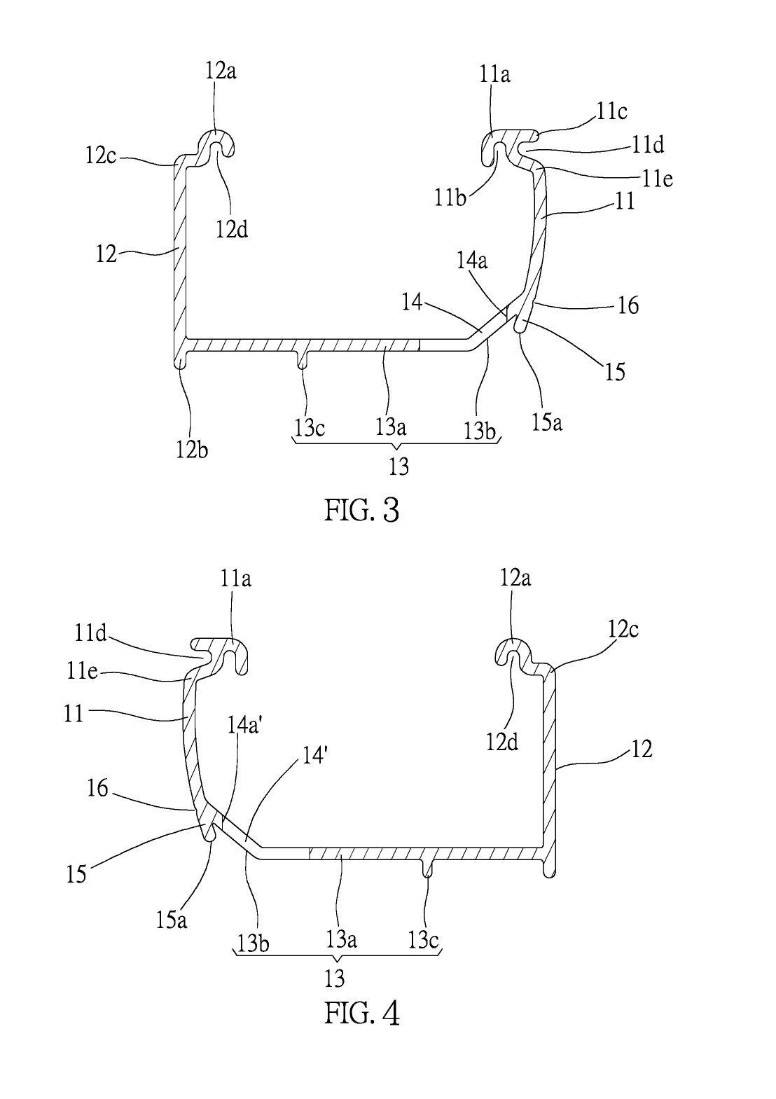

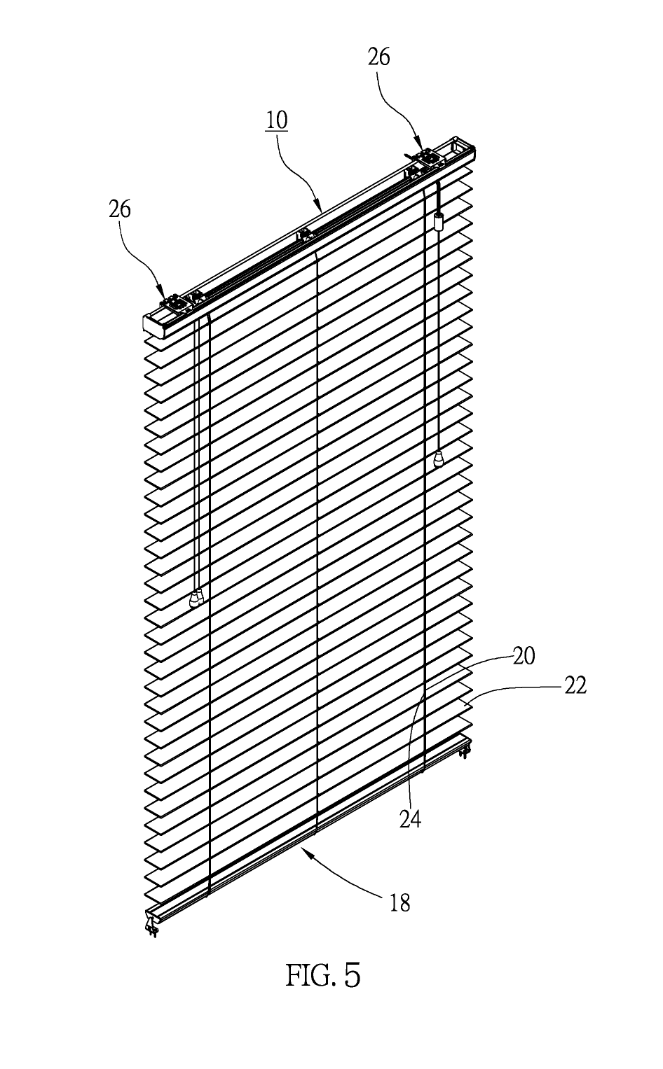

Referring to FIG. 3 and FIG. 4, the transverse plate 13 of the headrail 10 consists of a transverse portion 13a and an inclined portion 13b connected to each other, wherein a rib 13c bulges outward from a bottom surface of the transverse portion 13a of the transverse plate 13, and extends in a longitudinal direction of the transverse plate 13. In addition, the front side plate 11 slightly bulges outward, and is connected to the inclined portion 13b. The rear side plate 12 is connected to the transverse portion 13a. Whereby, a cross section of the headrail 10 is U-shaped.

A top edge of the front side plate 11 of the headrail 10 is bent inward to form a bend 11e, and the bend 11e is further connected to a hooked rib 11a. However, in other embodiments, the hooked rib 11a could be omitted. The hooked rib 11a bends inward and downward, wherein a groove 11b is formed between the hooked rib 11a and an inner surface of the front side plate 11. An outer side of the front side plate 11 has a first projection 11c near the top edge of the front side plate 11, in which the first projection 11c extends outward. As shown in FIG. 3, the first projection 11c extends outward transversely, and a groove 11d is formed between the first projection 11c and an inward bending portion of the top edge of the front side plate 11.

A top edge of the rear side plate 12 of the headrail 10 is bent inward to form a bend 12e, and the bend 12e is further connected to a hooked rib 12a. However, in other embodiments, the hooked rib 12a could be omitted. The hooked rib 12a bends inward and downward, in which a groove 12d is formed between the hooked rib 12a and an inner surface of the rear side plate 12. In addition, a bottom edge of the rear side plate 12 extends downward to form a second projection 12b, and an edge of the second projection 12b is lower than a junction of the rear side plate 12 and the transverse plate 13.

In other embodiments, the transverse plate 13 of the headrail 10 has at least one opening. As shown in FIG. 2 to FIG. 4, two openings 14, 14′ in long rectangle are provided on the transverse plate 13. A part of each of the openings 14, 14′ is located at the transverse portion 13a, while another part thereof is located at the inclined portion 13b. Each opening 14, 14′ has an edge 14a, 14a′ near the front side plate 11. In addition, a junction of the front side plate 11 and the inclined portion 13b of the transverse plate 13 has a protrusion 15 extending downward. An end edge 15a of the protrusion 15 is lower than the edge 14a, 14a′ of each the opening 14, 14′. Furthermore, the end edge 15a of the protrusion 15 is located out of a vertical projection range of each of the openings 14, 14′. However, the pattern of the protrusion 15 in FIG. 3 is not a limitation of the present invention, as long as the protrusion 15 could satisfy the aforementioned requirements, and a length thereof could be changed in a reasonable manner. For example, in other embodiments, an end edge of a protrusion could merely cover part of each of the openings on the transverse plate.

If the headrail 10 is made of plastic, such as Polyvinyl chloride (PVC), a shallow groove 16 could be formed on an outer surface of the junction of the front side plate 11 of the headrail 10 and the inclined portion 13b of the transverse plate 13. Whereby, the headrail 10 could be prevented from structural shrinkage due to the curing of plastic, because the plastic shrinkage might cause a deformation for an appearance of the headrail 10. In addition, the shallow groove 16 is not only beneficial to keep the appearance of the headrail 10 in place, but also creates a decorative effect. It is noted that, if the headrail 10 is made of aluminum or other material which would not tend to shrink or deform, the shallow groove 16 could be omitted. However, if the shallow groove 16 is provided for the purpose of decorating, the shallow groove 16 could be still formed by extrusion or stamping. In such a case, the shallow groove 16 could be positioned at anywhere on the front plate 11, and not limited to be at the junction of the front side plate 11 and the transverse plate 13.

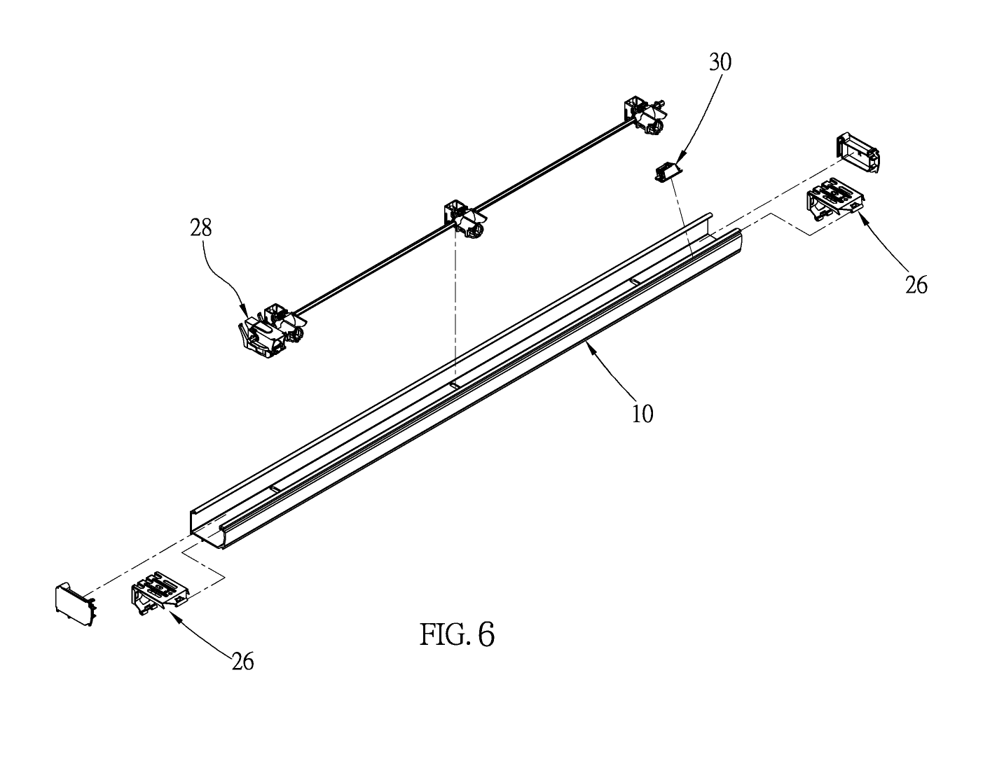

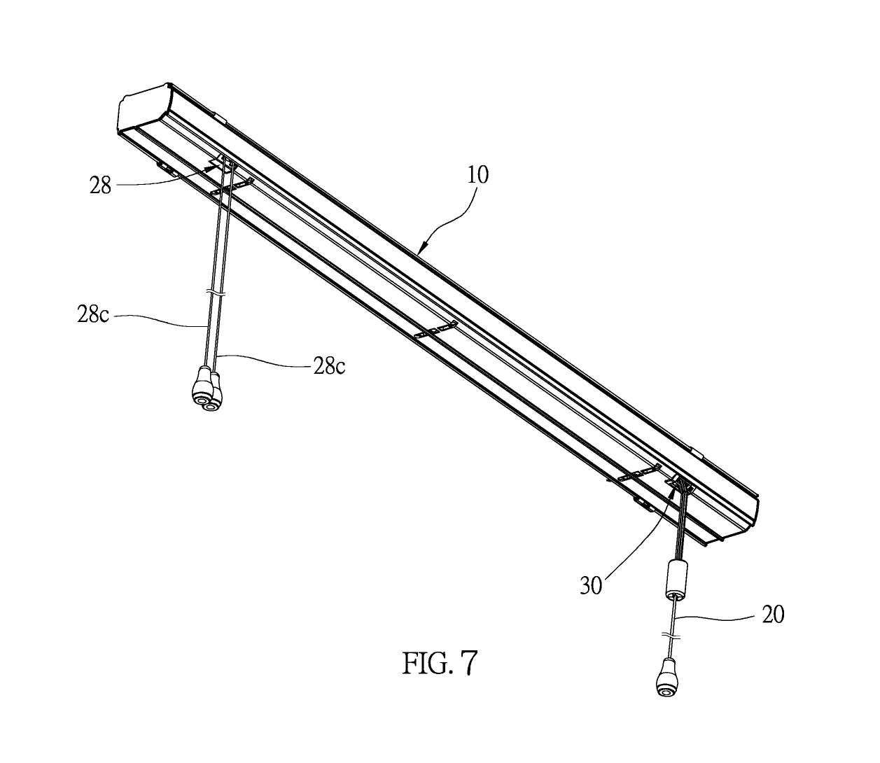

The structures of the headrail 10 have been explained above, and the use of the headrail would be discussed in details below. A covering device for an opening of a building is shown in FIG. 5 to FIG. 7. In the first embodiment, the covering device is a window covering, which includes a headrail 10, a movable bottom rail 18, a window covering material, and two mounting brackets 26.

In the first embodiment, the headrail 10 is fixed. The movable bottom rail 18 is located below the headrail 10, and could be moved through a plurality of lifting cords 20 to be raised and lowered relative to the headrail 10. The window covering material includes a plurality of slats 22, and the slats 22 are suspended in parallel between the headrail 10 and the movable bottom rail 18. Each of said lifting cords 20 is near two vertical strings of a ladder 24, and the lifting cords 20 and the vertical strings are respectively located on a front side and a rear side of the slats. In addition, at least one control unit is provided in the headrail 10, and is exposed through the opening of the headrail 10, whereby the control unit could tilt the slats 22 to change a shielding effect of the slats.

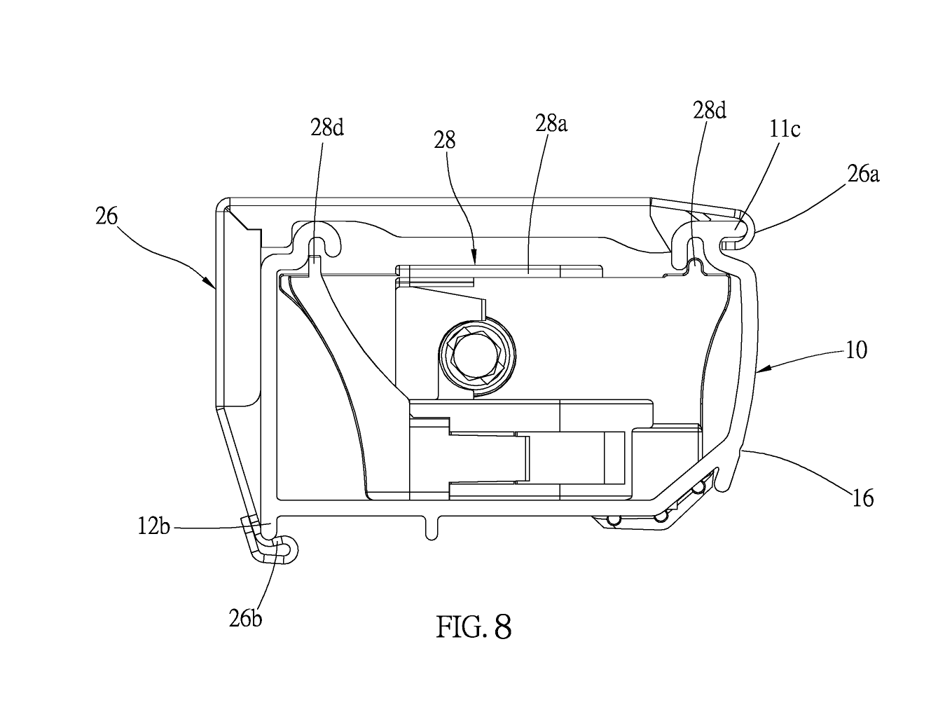

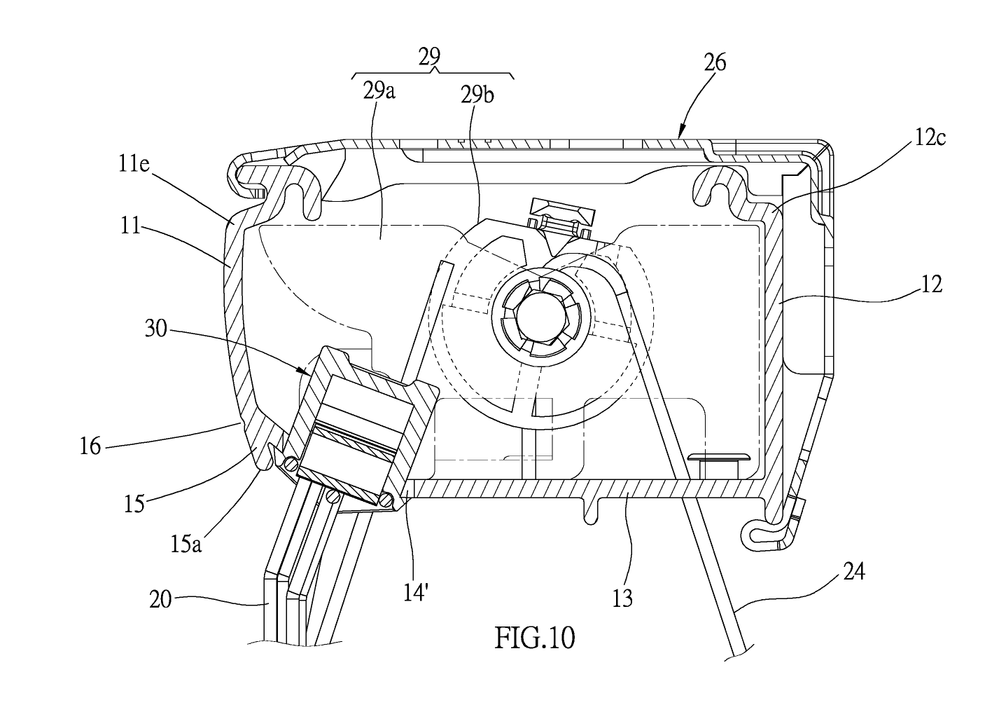

The mounting brackets 26 are provided on a fixture structure of the building (not shown), such as window frame, whereby the mounting brackets 26 and the headrail 10 could be assembled easily. As shown in FIG. 8 and FIG. 10, each of the mounting brackets 26 is substantially an L-shaped plate, wherein each of the mounting brackets 26 has a first hook 26a and a second hook 26b provided on two ends thereof. The first hook 26a is adapted to hook the first projection 11c of the headrail 10, while the second hook 26b is adapted to hook the second projection 12b of the headrail 10. Whereby, the headrail 10 could be fixed on the fixture structure.

In the first embodiment, the control unit includes a slat tilting structure and a control module. The ladder 24 could be controlled through the slat tilting structure to tilt the slats 22, whereby to provide different shielding effects. On the other hand, the lifting cords 20 could be released or locked through the control module to move or fix the movable bottom rail 18 to change an area covered by the window covering material. In other embodiments, the control unit merely includes the control module, but the slat tilting structure is omitted. The slat tilting structure and the control module are both well-known components, so it will only mention about the features related to the headrail 10 of the present invention in the following.

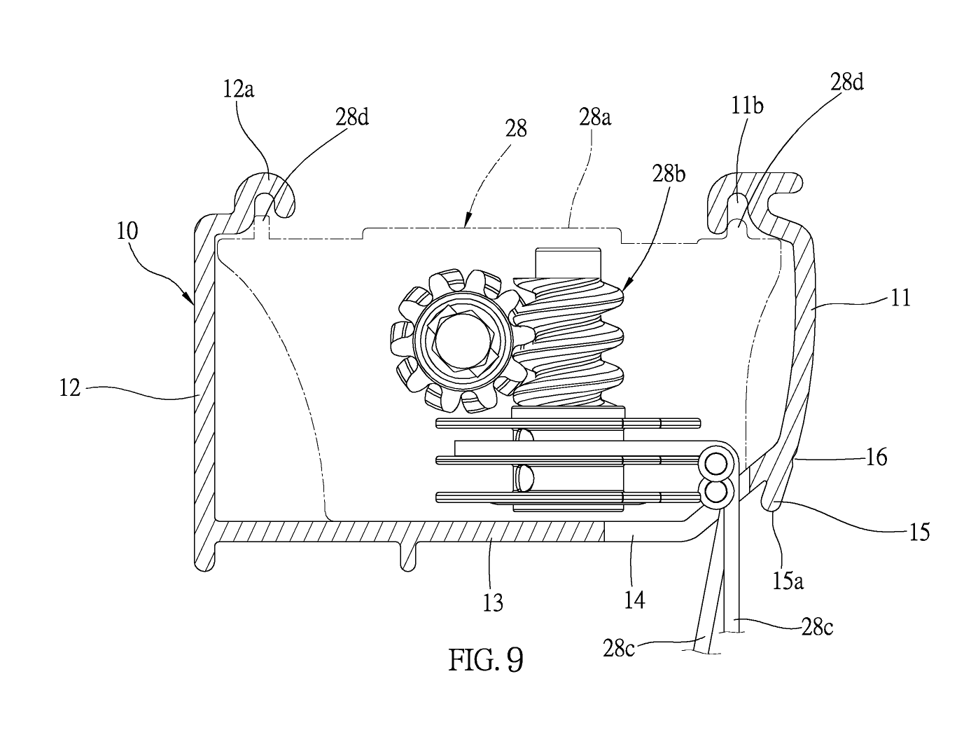

As shown in FIG. 8 to FIG. 10, the slat tilting structure includes a control member 28 and a rotating member 29. The control member 28 is connected to the rotating member 29 to tilt the slats 22. A part of the control member 28 extends out of the opening 14 of the headrail 10, and is exposed out of the headrail 10. In addition, part of the control member 28 is shielded by the protrusion 15 of the front side plate 11 of the headrail 10.

The control member 28 has a housing 28a, a tilting assembly 28b, and a tilting cord 28c, wherein the tilting assembly 28b is provided in the housing 28a to raise and lower the two vertical strings of each of the ladder 24. One end of the tilting cord 28c is connected to the tilting assembly 28b, while another end thereof extends out of the opening 14 of the headrail 10, and is exposed out of the headrail 10. The tilting cord 28c is adapted to tilt the slats 22. In the first embodiment, the opening 14 is covered by the housing 28a of the control member 28, wherein a top of the housing 28a has a plurality of protrusions 28d. One of the protrusions 28d engages with the groove 11b of the front side plate 11, while another one of the protrusions 28d abuts against the hooked rib 12a of the rear side plate 12. In other embodiments, the housing 28a of the control member 28 is fixed in the headrail 10 by the bend 11e of the front side plate 11 and the bend 12c of the rear side plate 12 of the headrail 10.

The rotating member 29 has a drum support 29a and a ladder drum 29b, wherein the ladder drum 29b is provided in the drum support 29a. The drum support 29a is fixed in the headrail 10 by the bend 11e of the front side plate 11 and the bend 12c of the rear side plate 12 of the headrail 10. In other embodiments, the drum support of the rotating member has at least one protrusion which is adapted to engage with or abut against the hooked rib of one or both of the front side plate and the rear side plate.

As shown in FIG. 10, the control module includes the lifting cords 20 and a cord lock 30. Each of the lifting cords 20 is connected to the movable bottom rail 18 with an end thereof, and extends through the headrail 10, the cord lock 30 and the opening 14′ to leave another end of the lifting cord 20 exposed out of the headrail 10. By pulling the exposed part of the lifting cord 20, the movable bottom rail 18 could be positioned at any position as required. The cord lock 30 is detachably engaged with the headrail 10, and covers the opening 14′. The cord lock 30 is adapted to position said lifting cord 20, wherein a part of the cord lock 30 extends out of the other opening 14′ to be exposed out of the headrail 10. In addition, part of the cord lock 30 is shielded by the protrusion 15 of the front side plate 11 of the headrail 10.

The protrusion 15 of the front side plate 11 is near the openings 14, 14′, so that the tilting cord 28c and the lifting cords 20 would not contact with the protrusion 15 while being pulled outward. Whereby, the operation would be smooth. Also, since the end 15a of the protrusion 15 is lower than the edges 14a, 14a′ of the openings 14, 14′, the openings 14, 14′ can be shielded by the protrusion 15. Whereby, an appearance of the headrail 10 would be simple and clean, which enhances the quality of the whole covering device. Furthermore, because the bottom surface of the transverse plate 13 has the rib 13c provided thereon, the rib 13c could prevent the light leaking in through the slit between a bottom surface of the headrail 10 and the top edge of the topmost slat 22 when the slats are rotated into a vertical position, which provides a better shielding effect.

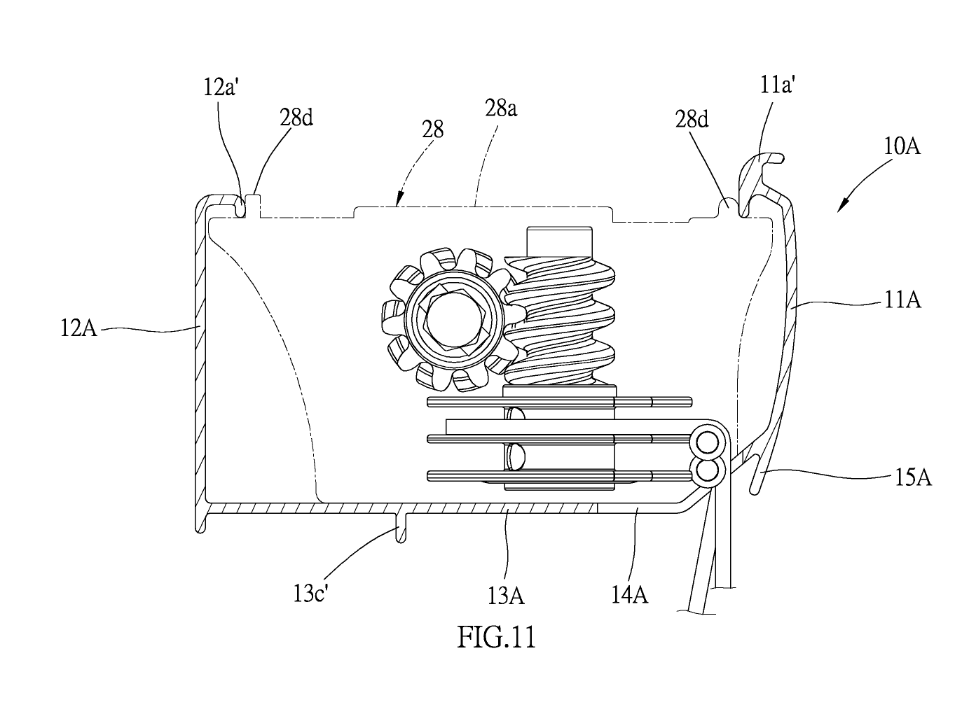

A headrail 10A of a second embodiment of the present invention is shown in FIG. 11, including a front side plate 11A, a rear side plate 12A, and a transverse plate 13A. A hooked ribs 11a′, 12a′ of the headrail 10A are different from the hooked ribs 11a, 12a described in the first embodiment, and the front side plate 11A has no shallow groove in the second embodiment. In addition, the relation between the opening 14A and the protrusion 15A on the headrail 10A is the same as the headrail 10 in these two embodiments. When the headrail 10A is applied to a window covering, two facing surfaces of the hooked ribs 11a′, 12a′ would respectively abut against two outer surfaces of the protrusions 28d of the housing 28a of the control member 28. Whereby the position of the control member 28 in the headrail 10 could be fixed. Furthermore, a bottom surface of the transverse plate 13A of the headrail 10A has a rib 13c′ provided thereon, wherein the rib 13c′ would be helpful to provide a better shielding effect.

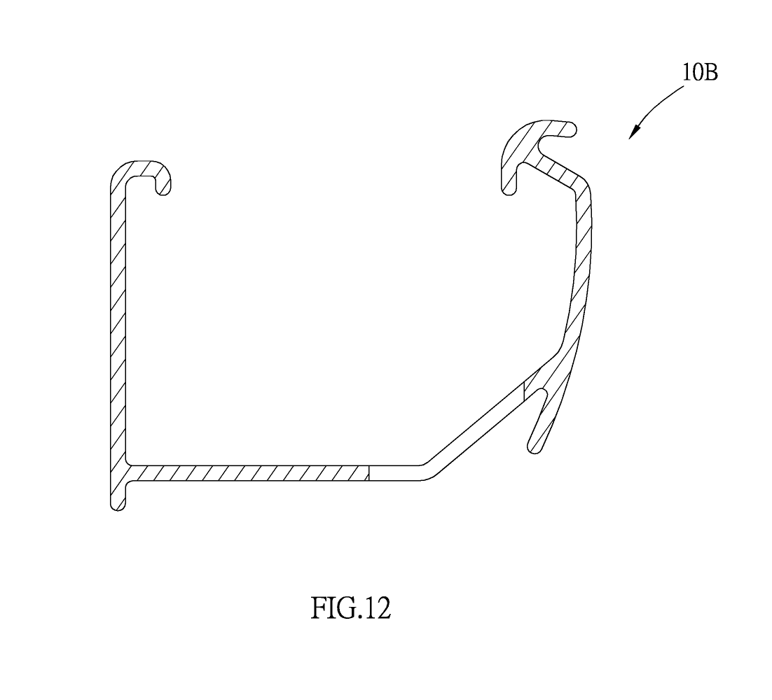

A headrail 10B shown in FIG. 12 is smaller than the headrail 10A shown in FIG. 11, and could be applied to a smaller window covering. The headrail 10B has almost the same structure with the headrail 10A, except that a bottom surface of the transverse plate of the headrail 10B has no rib. In addition, a proportion of the protrusion of the front side plate and the whole front side plate of the headrail 10B, and a proportion of the transverse portion and the inclined portion of the transverse plate are both different from those seen on the headrail 10A of the second embodiment.

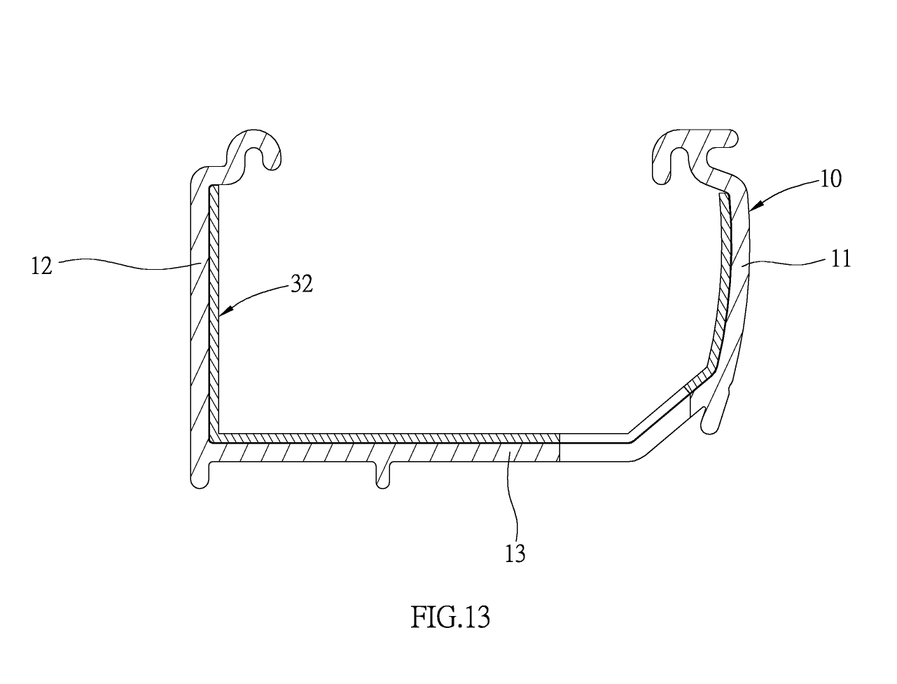

A supporting member could be further provided in a headrail to enhance the structural strength. As shown in FIG. 13, a supporting member 32, which is substantially U-shaped, is provided in the headrail 10 to abut against an inner surface of the front side plate 11, an inner surface of the rear side plate 12, and an inner surface of the transverse plate 13 of the headrail 10. Whereby, the supporting member 32 could provide lateral support to the front side plate 11 and the rear side plate 12 to prevent the headrail 10 from deformation. Especially, when the headrail 10 is made of plastic or wood, the supporting member 32 could be made of rigid material, such as metal, to reduce the problem of the headrail deformation. In the first embodiment, a projection area of the supporting member 32 overlaps the opening of the headrail 10, and an opening of the supporting member 32 substantially aligns with the opening of the headrail 10.

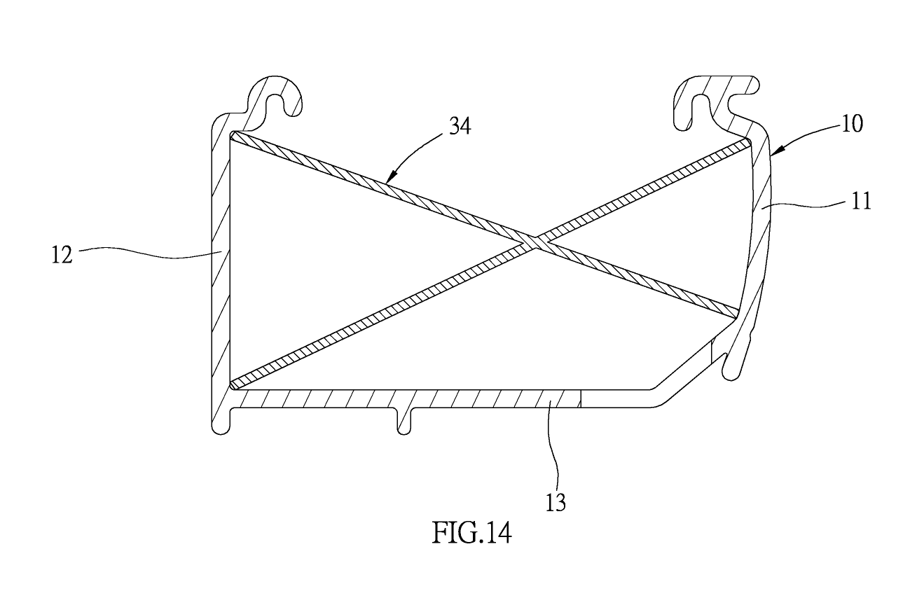

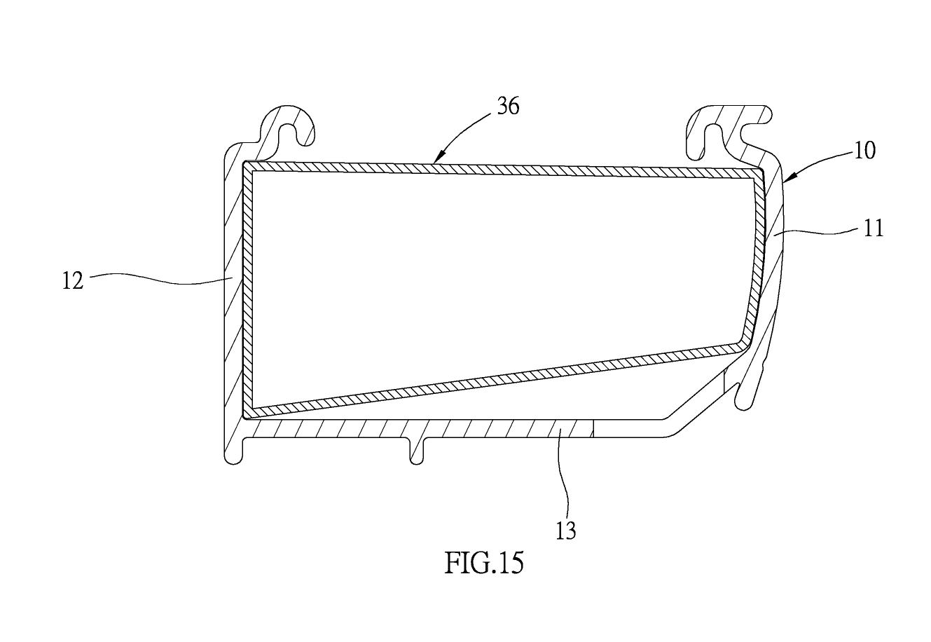

In FIG. 14, a cross section of a supporting member 34 is substantially X-shaped, wherein each end of the supporting member 34 abuts against the inner surface of the front side plate 11, the inner surface of the rear side plate 12, and the inner surface of the transverse plate 13 of the headrail 10. In FIG. 15, a supporting member 36 is a trapezoidal tube, wherein an outer segment of the supporting member 36 abuts against the inner surface of the front side plate 11, the inner surface of the rear side plate 12, and the inner surface of the transverse plate 13 of the headrail 10. Said supporting members 34, 36 could also provide lateral support to the front side plate 11 and the rear side plate 12 to prevent the headrail 10 from deformation. In summary, the supporting members 32, 34, 36 are all adapted to prevent the headrail 10 from deformation. However, the shapes, sizes, and proportions of the supporting members 32, 34, 36 are not limitations of the present invention, as long as at least one of the side plates could be supported.

It must be pointed out that the embodiments described above are only some preferred embodiments of the present invention. All equivalent structures which employ the concepts disclosed in this specification and the appended claims should fall within the scope of the present invention.

What is claimed is:

1. A headrail structure, comprising a front side plate, a rear side plate, and a transverse plate, wherein the front side plate and the rear side plate are respectively connected to two different long edges of the transverse plate; the headrail structure is characterized in that:
the transverse plate has at least one opening; and
the front side plate has a protrusion extending downward, wherein the protrusion is near the opening.

2. The headrail structure of claim 1, wherein the protrusion is located out of a vertical projection range of the opening.

3. The headrail structure of claim 1, wherein the protrusion shields a part of the opening.

4. The headrail structure of claim 1, wherein the opening has an edge near the front side plate, and an end edge of the protrusion is lower than the edge of the opening.

5. The headrail structure of claim 1, wherein an outer side of the front side plate has a shallow groove extending in a longitudinal direction of the transverse plate.

6. The headrail structure of claim 1, wherein the shallow groove is located on an outer side of a junction of the front side plate and the transverse plate.

7. The headrail structure of claim 1, wherein a bottom surface of the transverse plate has a rib bulged outward therefrom, and the rib extends in a longitudinal direction of the transverse plate.

8. The headrail structure of claim 1, wherein the transverse plate comprises a transverse portion and an inclined portion connected to each other; a part of the opening is located on the transverse portion of the transverse plate, while another part thereof is located on the inclined portion of the transverse plate; the front side plate is connected to the inclined portion of the transverse plate, and the rear side plate is connected to the transverse portion of the transverse plate.

9. The headrail structure of claim 1, wherein an outer side of the front side plate has a first projection near the top edge of the front side plate, and the first projection extends outward.

10. The headrail structure of claim 1, wherein a bottom edge of the rear side plate extends downward to form a second projection, and an edge of the second projection is lower than a junction of the rear side plate and the transverse plate.

11. The headrail structure of claim 1, wherein a top edge of at least one among the front side plate and the rear side plate is bent inward to connect to a hooked rib.

12. The headrail structure of claim 1, wherein a top edge of at least one among the front side plate and the rear side plate is bent inward to form a bend.

13. The headrail structure of claim 12, wherein the bend is connected to a hooked rib.

14. A covering device for an opening of a building, comprising a fixed headrail being the same as the headrail structure of claim 1, a movable bottom rail, and a window covering material provided between the fixed headrail and the movable bottom rail, wherein the window covering material is controllable through at least one control unit; the covering device is characterized in that:
the control unit is provided in the fixed headrail, and is exposed through the opening thereof.

15. A covering device for an opening of a building, comprising a fixed headrail, a movable bottom rail, and a window covering material provided between the fixed headrail and the movable bottom rail, wherein the window covering material is controlled through at least one control unit; the covering device is characterized in that:
the fixed headrail comprises a front side plate, a rear side plate, and a transverse plate; the front side plate and the rear side plate are respectively connected to two different long edges of the transverse plate, and the transverse plate has at least one opening, wherein the front side plate has a protrusion extending downward, and the protrusion is near the opening; and
the control unit is provided in the fixed headrail, and is exposed through the opening.

16. The covering device of claim 15, wherein the window covering material comprises a plurality of slats, which are suspended between the fixed headrail and the movable bottom rail through at least one ladder; the control unit comprises a control member and a rotating member, wherein a part of the control member extends out of the opening to be exposed out of the headrail; the control member is connected to the rotating member to tilt the slats; a part of the control member is shielded by the protrusion of the front side plate of the fixed headrail.

17. The covering device of claim 16, wherein a top edge of at least one among the front side plate and the rear side plate of the headrail is bent inward to connect to a hooked rib; a housing of at least one among the control member and the rotating member has a protrusion engaging with or abutting against the hooked rib.

18. The covering device of claim 16, wherein a top edge of at least one among the front side plate and the rear side plate is bent inward as a bend; the housing of at least one among the control member and the rotating member is fixed by the bend.

19. The covering device of claim 18, wherein the bend is connected to a hooked rib; a housing of at least one among the control member and the rotating member has a protrusion engaging with or abutting against the hooked rib.

20. The covering device of claim 15, wherein the control unit comprises a lifting cord and a cord lock; the lifting cord extends through the cord lock and the opening of the headrail to be exposed out of the headrail; the lifting cord is adapted to raise and lower the movable bottom rail; the cord lock is adapted to position the lifting cord, wherein a part of the cord lock extends out of the opening, and is exposed out of the headrail; the exposed part of the cord lock is shielded by the protrusion of the front side plate of the headrail.

21. The covering device of claim 15, wherein an outer surface of the front side plate of the headrail has a first projection near a top edge of the front side plate, and the first projection extends outward; a bottom edge of the rear side plate forms a second projection, and an edge of the second projection is lower than a junction of the rear side plate and the transverse plate; the covering device further comprises at least one fixing member adapted to fix the covering device on a fixture structure, wherein the fixing member comprises a first hook and a second hook; the first hook is adapted to hook the first projection of the front side plate of the headrail, while the second hook is adapted to hook the second projection of the rear side plate of the headrail.

22. The covering device of claim 15, further comprises a supporting member provided in the headrail, wherein the supporting member abuts against at least one among the front side plate, the rear side plate, and the transverse plate of the headrail.

23. The covering device of claim 22, wherein a projection area of the supporting member overlaps the opening of the headrail, and an opening of the supporting member substantially aligns with the opening of the headrail.
